(19) United States
(12) Patent Application Publication
(10) Pub. No.: US 2009/0102624 A1
(43) Pub. Date: Apr. 23, 2009

(54) PORTABLE COMPUTER WITH BURGLARPROOF FUNCTION AND CONTROL METHOD THEREOF

(76) Inventor: Ming-Huei TSAI, Taipei (TW)

Correspondence Address: Muncy, Geissler, Olds & Lowe, PLLC, P.O. BOX 1364, FAIRFAX, VA, 22038-1364, US

(21) Appl. No.: 12/209,969

(22) Filed: Sep. 12, 2008

(30) Foreign Application Priority Data
Oct. 19, 2007 (TW) 096139218

(51) Int. Cl. B60R 25/10

(52) U.S. Cl. 340/426.25

(57) ABSTRACT

A control method for a portable computer, which has a basic input output system (BIOS) and a storage module stored a plurality of data, includes the steps of enabling a burglarproof status, detecting a displacing signal to determine whether the portable computer has displacement under the burglarproof status, enabling an alert status if the portable computer has displacement, and stopping the access of the data stored in the storage module and informing the alert status to the BIOS.

### CROSS REFERENCE TO RELATED APPLICATIONS

This Non-provisional application claims priority under 35 U.S.C. §119(a) on Patent Application No(s). 096139218 filed in Taiwan, Republic of China on Oct. 19, 2007, the entire contents of which are hereby incorporated by reference.

### BACKGROUND OF THE INVENTION

1. Field of Invention

The invention relates to a portable computer and, more particularly, to a portable computer with a burglarproof function.

2. Related Art

From the development of the computer, various files and data stored as written information in the conventional method are stored in different storage media. However, although informationalization makes the copy and transmission easy and fast, the data security has been paid more attention because of the convenient transmission.

The preset common method for protecting data utilizes the file encryption, and this method can utilize a password or give a specific sign (such as the fingerprint) to protect specific data, so that the data is kept secret and is not easy to be stolen and embezzled.

As we all know, the encrypted data still can be decrypted and obtained by persons having encrypting and decrypting skills, and therefore, the simple encrypting actions is not enough for the need of relative important confidential files.

### SUMMARY OF TIE INVENTION

The objective of the invention is to provide a portable computer with a burglarproof function which can provide data confidentiality and system security.

To obtain the above or other objectives, the invention provides a control method for a portable computer. The portable computer has a basic input output system (BIOS) and a storage module storing a plurality of data. The control method includes the following steps of enabling a burglarproof status, detecting a displacing signal to determine whether the portable computer has displacement in the burglarproof status, enabling an alert status when the portable computer is determined to have displacement, and stopping the access of the data in the storage module and informing the BIOS of the alert status.

To obtain the above or the other objectives, the invention provides a portable computer including a storage module, a displacement detecting module, a control module and a BIOS. The storage module stores a plurality of data, the displacement detecting module generates a displacing signal when it detects the displacement of the portable computer, the control module generates an alert signal according to the displacing signal to enter the portable computer into an alert status, and the BIOS conceals or locks the storage module according to the alert signal to stop the access of the data.

In the invention, the portable computer with a burglarproof function and the control method thereof utilize a displacement detecting module to detect a displacing signal in the burglarproof status to determine whether the portable computer is moved. When the displacement detecting module detects the displacement, it can instantly send an alert signal to prohibit the access of data and can inform the system owner or the user by a proper method to reduce the lost.

These and other features, aspects, and advantages of the present invention will become better understood with regard to the following description, appended claims, and accompanying drawings.

### BRIEF DESCRIPTION OF THE DRAWINGS

FIG. 1 is a block diagram showing a portable computer according to a preferred embodiment of the invention.

FIG. 2 is a detailed block diagram showing a portable computer according to a preferred embodiment of the invention.

FIG. 3 is flowchart showing a control method for a portable computer according to a preferred embodiment of the invention.

### DETAILED DESCRIPTION OF THE INVENTION

The portable computer and the control method thereof according to the preferred embodiment of the invention is described hereinbelow with the accompanying drawings.

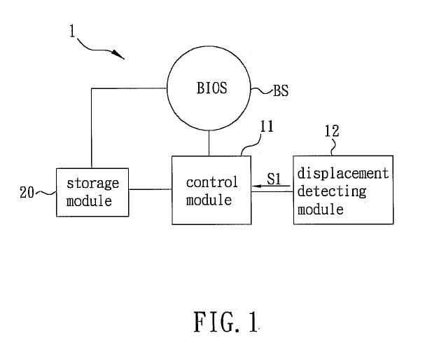

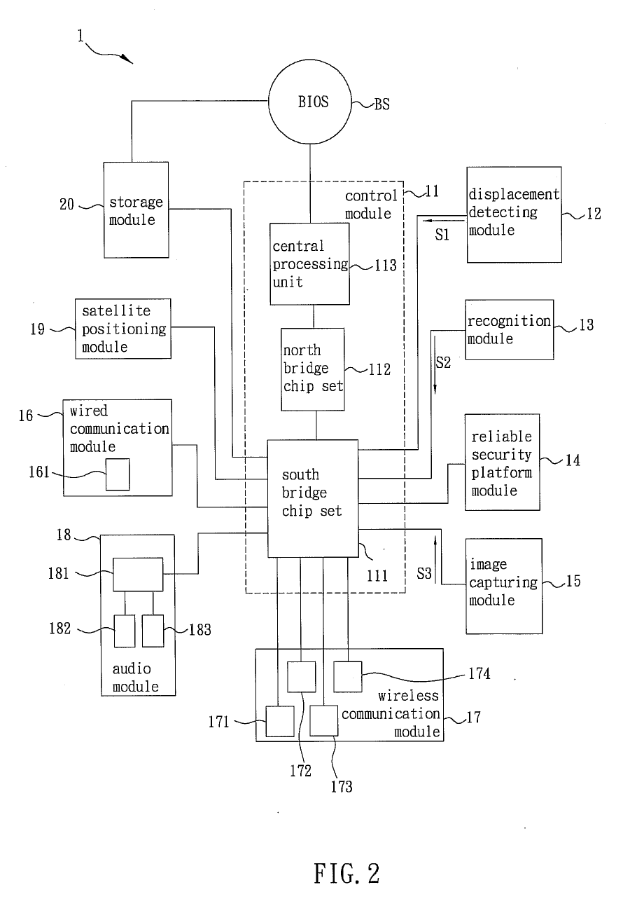

Please refer to FIG. 1. The portable computer 1 of the preferred embodiment of the invention includes a control module 11, a displacement detecting module 12, a recognition module 13 and a reliable security platform module 14. The portable computer 1 of the preferred embodiment of the invention is also described with the FIG. 2. The portable computer 1 further includes an image capturing module 15, a communication module, an audio module 18, a satellite positioning module 19, and a storage module 20.

The control module 11 also includes a south bridge chip set 111, a north bridge chip set 112 and a central processing unit (CPU) 113. The north bridge chip set 112 is electrically connected to the south bridge chip set 111 and the CPU 113, respectively, to transmit data or signals to each other. In addition, the CPU 113 is electrically connected to a basic input output system (BIOS) to control the operation of the portable computer 1.

The storage module 20 is, for example, a hard disk and is electrically connected to the south bridge chip set 111 of the control module 11. In addition, the storage module 20 stores a plurality of data.

The displacement detecting module 12 is electrically connected to the south bridge chip set 111 of the control module 11 via a system management interface (SMI). The displacement detecting module 12 can include an accelerating sensor which can be a bi-dimensional accelerating sensor or a three-dimensional accelerating sensor. When the displacement detecting module 12 detects the displacement, it generates a displacing signal S1 to the south bridge chip set 111 of the control module 11 instantly.

The recognition module 13 is electrically connected to the south bridge chip set 111 of the control module 11 via a universal serial bus (USB), and the recognition module 13 can be a fingerprint reader and even can be a high level product such as an iris identifier or a vein identifier. After the recognition module 13 recognizes an object, it generates a recognition signal S2 to the control module 11. Herein, the recognition signal S2 can be used for encrypting the data (giving a sign to the data) or authorization contrast, and it is not limited.

The reliable security platform module 14 is electrically connected to a south bridge chip set 111 of the control module 11 via a low pin count (LPC) interface and codes the data to make the data confidential.

The image capturing module 15 is electrically connected to the south bridge chip set 111 of the control module 11 and includes an image capturing device such as a camera. After the image capturing module 15 captures an image S3, it transmits the image S3 to the control module 11 to make a signal processing instantly.

The communication module has a wired communication module 16 and a wireless communication module 17 which are electrically connected to the south bridge chip set 111 of the control module 11, respectively. The wired communication module 16 has a wired network chip 161 to process the wired network signal. The wireless communication module 17 can include a Bluetooth chip set 171, a wireless network chip set 172, an ultra wideband network (UWB) chip set 173 and a wireless wide area network chip set 174 which are electrically connected to the south bridge chip set 111 to transmit data to the control module 11.

The communication module can transmit the image S3 captured by the image capturing module 15 to the outside via the electronic mail by the control module 11, and it also can transmit the image S3 to the outside in a wireless communication manner. The so-called outside herein means devices or addresses such as computers, electronic mail account numbers, portable communication devices and so on, which are appointed by users.

The audio module 18 is electrically connected to the south bridge chip set 111 of the control module 11 and has an audio processing chip 181, a loudspeaker 182 and a microphone 183 to execute the functions of processing the voice, inputting and outputting the voice. The loudspeaker 182 and the microphone 183 are electrically connected to the audio processing chip 181, respectively.

The satellite positioning module 19 is electrically connected to the south bridge chip set 111 of the control module 11. When the satellite positioning module 19 is enabled, it can send a piece of position information of the computer device to the outside.

The portable computer 1 can have the combination of the above components according to the actual need, and portable computer and the data stored therein can have a best protecting effect. The control method for the portable computer 1 with a burglarproof function is described hereinbelow with the related drawings.

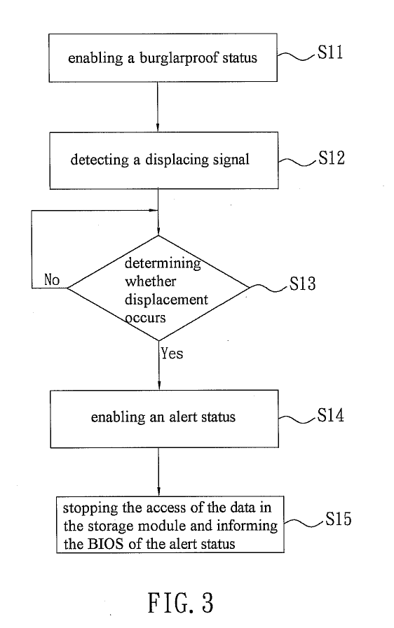

Please refer to FIG. 3 and FIG. 2. The control method for the portable computer 1 of the preferred embodiment of the invention includes the steps S11 to S15. The data stored in the storage module 20 is coded by the recognition module 13 and the reliable security platform module 14.

The step S11 is enabling a burglarproof status, and in the step S11, the portable computer 1 can be set in a burglarproof status. The burglarproof status can be enabled after the computer passes a preset idle time, or it can be enabled by the user manually.

In the steps S12 and S13, the displacement detecting module 12 continues monitoring and detecting a displacing signal S1 in the burglarproof status to determine whether the portable computer 1 has displacement. In the step S14, when the portable computer 1 is determined to have a displacement, that is, the portable computer 1 is moved, an alert status is enabled.

In the step S15, the access of the data stored in the storage module 20 is stopped in the alert status, and the alert status is informed to the BIOS BS by the control module 11. The BIOS BS conceals or locks the storage module 20 to prohibit all the access.

In the alert status, the portable computer 1 with a burglarproof function also can execute the following operations simultaneously. The hinage capturing module 15 captures the image S3 around the portable computer 1 and transmits the image S3 to the outside via the communication module. The audio module 17 outputs an alert sound effect to frighten the intruder. The alert status is transmitted to the outside by the communication module, or the satellite positioning module 19 transmits the position information of the portable computer 1 to the device appointed by the user. Therefore, the user can know the position of the portable computer 1 via the global positioning system (GPS) to increase the chance of getting the portable computer 1 back.

The above steps are just used for describing. The executing sequence and each step can be changed according to the setting made by the user, and they are not limited.

To sum up, for the portable computer and the control method thereof of the invention, the operating system and the BIOS lock the storage module and prohibit the access except that the user having legal authorization relieve the alert. Even if the system is restarted or reset, the BIOS conceals the storage module. In addition, since the important data are all coded by the recognition module and reliable security platform module, even if the intruder takes the storage module out and stalls the storage module on the other system, the data cannot be obtained. Furthermore, the portable computer can transmit the image to the user or the outside in various manners by the image capturing module, or the position information can be obtained via the satellite positioning system. Therefore, the confidentiality and the security of the data and the system can be improved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A control method for a portable computer having a basic input output system (BIOS) and a storage module storing a plurality of data, the control method comprising the steps of:
enabling a burglarproof status;
detecting a displacing signal to determine whether the portable computer has displacement in the burglarproof status;
enabling an alert status when the portable computer is determined to have the displacement; and
stopping the access of the data stored in the storage module and informing the basic input output system (BIOS) of the alert status.

2. The control method according to claim 1, wherein the control method further comprises the step of coding the data before enabling the alert status.

3. The control method according to claim 1, wherein the control method further comprises the step of capturing at least an image around the portable computer and transmitting the image to the outside after enabling the alert status.

4. The control method according to claim 1, wherein the control method comprises the step of outputting an alert sound effect after enabling the alert status.

5. The control method according to claim 1, wherein the control method further comprises the step of transmitting the alert status to the outside after enabling the alert status.

6. The control method according to claim 1, wherein the control method further comprises the step of transmitting a piece of position information of the portable computer to the outside after enabling the alert status.

7. The control method according to claim 1, wherein the alert status is enabled after a preset idle time.

8. The control method according to claim 1, wherein the burglarproof status is enabled by a user.

9. A portable computer comprising:
a storage module storing a plurality of data;
a displacement detecting module which generates a displacing signal when it detects displacement;
a control module which generates an alert signal according to the displacing signal to enter the portable computer into an alert status; and
a basic input output system (BIOS) which conceals or locks the storage module according to the alert signal to stop the access of the data.

10. The portable computer according to claim 9, further comprising a recognition module and a reliable security platform module which give the data a sign and code the data, respectively.

11. The portable computer according to claim 10, wherein the recognition module is a fingerprint reader.

12. The portable computer according to claim 9, wherein the control module comprises a south bridge chip set.

13. The portable computer according to claim 9, wherein the displacement detecting module has an accelerating sensor.

14. The portable computer according to claim 9, wherein the portable computer further comprises:
an image capturing module which captures at least an image around the portable computer according to the alert signal; and
a communication module transmitting the image to the outside.

15. The portable computer according to claim 9 further comprising an audio module which outputs an audio signal according to the alert signal.

16. The portable computer according to claim 9 further comprising a satellite positioning module which transmits a piece of position information to the outside according to the alert signal.
